(19) United States
(12) Patent Application Publication
(10) Pub. No.: US 2020/0156221 A1
(43) Pub. Date: May 21, 2020

(54) RATCHET WRENCH WITH PUSHROD

(71) Applicant: KABO TOOL COMPANY, Taichung City (TW)

(72) Inventor: Chih-Ching HSIEH, Taichung City (TW)

(21) Appl. No.: 16/681,779

(22) Filed: Nov. 12, 2019

(30) Foreign Application Priority Data
Nov. 21, 2018 (TW) 107141525

(51) Int. Cl. B25B 13/46

(52) U.S. Cl. CPC B25B 13/462

(57) ABSTRACT

A ratchet wrench with a pushrod includes a base body, a ratchet and the pushrod. The base body includes a driving portion and a sliding path. The driving portion is disposed at one end of the base body, and includes a receiving space. The ratchet is disposed in the receiving space, and includes a continuous tooth-shaped structure. The pushrod is disposed in the sliding path, and includes two tooth portions and a pushrod cross section. One of the tooth portions is engaged to the continuous tooth-shaped structure. The pushrod cross section includes a first cross section and a second cross section. The first cross section is a rectangular shape. The second cross section is an arc shape and connected to the first cross section. The pushrod cross section has a first horizontal length and a first vertical length. The first vertical length is greater than the first horizontal length.

### RELATED APPLICATIONS

This application claims priority to Taiwan Application Serial Number 107141525, filed Nov. 21, 2018, which is herein incorporated by reference.

### BACKGROUND

### Technical Field

The present disclosure relates to a ratchet wrench. More particularly, the present disclosure relates to a ratchet wrench with a pushrod.

### Description of Related Art

FIG. 11 is a schematic view of a conventional ratchet wrench 500. In FIG. 11, the conventional ratchet wrench 500 has a pushrod being circle-shaped. However, due to the pushrod 510 of the conventional ratchet wrench 500 being circle-shaped, an engaging position between a tooth portion of the pushrod 510 and a ratchet 520 would be lower, and an engaging area between the tooth portion of the pushrod 510 and the ratchet 520 would be smaller, thus, it is unfavorable for bearing higher torque value. Further, the adaptability of the ratchet 520 would be decreased due to the shape of the pushrod 510, so that the conventional ratchet wrench 500 would be damaged easily.

### SUMMARY

According to one embodiment of the present disclosure, a ratchet wrench with a pushrod includes a base body, a ratchet, the pushrod and a positioning assembly. The base body includes a driving portion, a sliding path and a positioning slot. The driving portion is disposed at one end of the base body, and includes a receiving space. The sliding path is disposed in the base body and communicated to the receiving space. The positioning slot is communicated to the sliding path. The ratchet is disposed in the receiving space, and includes a continuous tooth-shaped structure. The continuous tooth-shaped structure is disposed at an outer circumference of the ratchet. The pushrod is disposed in the sliding path, and includes two tooth portions, two pushrod ends, a positioning portion and a pushrod cross section. One of the two tooth portions is engaged to the continuous tooth-shaped structure. The two pushrod ends are disposed at an end of each of the tooth portions, respectively. The positioning portion is corresponded to the positioning slot, and includes at least two positioning grooves. The pushrod cross section includes a first cross section and a second cross section. The first cross section is a rectangular shape. The second cross section is an arc shape, and connected to the first cross section. The pushrod cross section has a first horizontal length and a first vertical length, and the first vertical length is greater than the first horizontal length. The positioning assembly is disposed in the positioning slot, wherein the positioning assembly is elastically abutted against the positioning portion.

According to another embodiment of the present disclosure, a ratchet wrench with a pushrod includes a base body, a ratchet, the pushrod and a positioning assembly. The base body includes a driving portion, a sliding path and a positioning slot. The driving portion is disposed at one end of the base body, and includes a receiving space. The sliding path is disposed in the base body and communicated to the receiving space. The positioning slot is communicated to the sliding path. The ratchet is disposed in the receiving space, and includes a continuous tooth-shaped structure. The continuous tooth-shaped structure is disposed at an outer circumference of the ratchet. The pushrod is disposed in the sliding path, and includes two tooth portions, two pushrod ends, a positioning portion and a pushrod cross section. One of the two tooth portions is engaged to the continuous tooth-shaped structure. The two pushrod ends are disposed at an end of each of the tooth portions, respectively. The positioning portion is corresponded to the positioning slot, and includes at least two positioning grooves. The pushrod cross section includes a first cross section and a second cross section. The first cross section is a rectangular shape. The second cross section is an arc shape, and connected to the first cross section. The pushrod cross section has a first horizontal length and a first vertical length, and the first horizontal length is greater than the first vertical length. The positioning assembly is disposed in the positioning slot, wherein the positioning assembly is elastically abutted against the positioning portion.

### BRIEF DESCRIPTION OF THE DRAWINGS

The present disclosure can be more fully understood by reading the following detailed description of the embodiment, with reference made to the accompanying drawings as follows:

FIG. 1 is a schematic view of a ratchet wrench with a pushrod according to an embodiment of the present disclosure.

FIG. 2 is an exploded view of the ratchet wrench with the pushrod according to the embodiment of FIG. 1.

FIG. 3 is a cross-sectional view along line A-A of the ratchet wrench with the pushrod according to the embodiment of FIG. 2.

FIG. 4 is a perspective view of one status of a part of the ratchet wrench with the pushrod according to the embodiment of FIG. 1.

FIG. 5 is a perspective view of another status of a part of the ratchet wrench with the pushrod according to the embodiment of FIG. 1.

FIG. 6 is a schematic view of the pushrod according to the embodiment of FIG. 1.

FIG. 7 is another schematic view of the pushrod according to the embodiment of FIG. 1.

FIG. 8 is a side view of a part of the ratchet wrench with the pushrod according to the embodiment of FIG. 1.

FIG. 9 is a schematic view of a pushrod cross section of a ratchet wrench with a pushrod according to another embodiment of the present disclosure.

FIG. 10 is a side view of a part of the ratchet wrench with the pushrod according to the embodiment of FIG. 9.

FIG. 11 is a schematic view of a conventional ratchet wrench.

### DETAILED DESCRIPTION

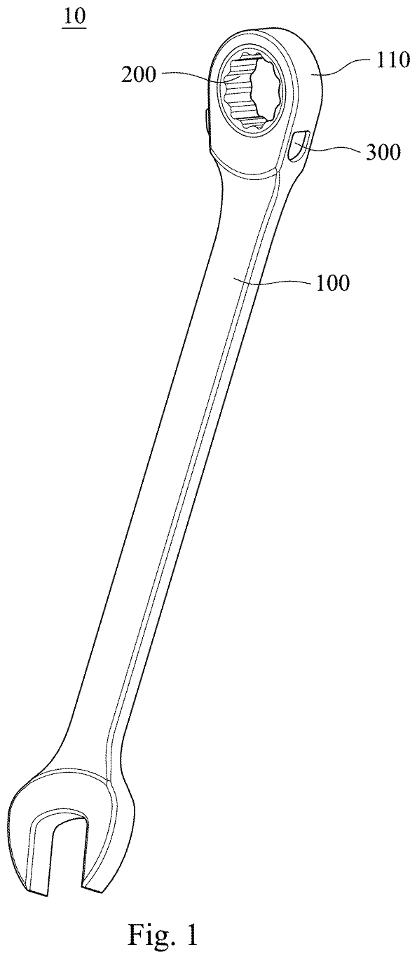

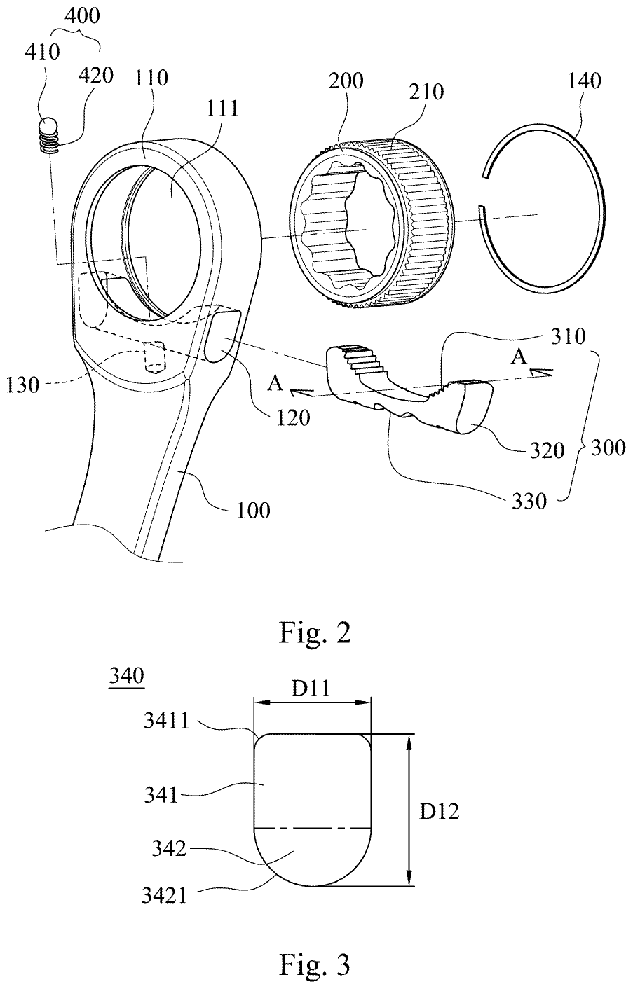

FIG. 1 is a schematic view of a ratchet wrench 10 with a pushrod 300 according to an embodiment of the present disclosure. FIG. 2 is an exploded view of the ratchet wrench 10 with the pushrod 300 according to the embodiment of FIG. 1. FIG. 3 is a cross-sectional view along line A-A of the ratchet wrench 10 with the pushrod 300 according to the embodiment of FIG. 2. In FIGS. 1, 2 and 3, the ratchet wrench 10 with the pushrod 300 includes a base body 100, a ratchet 200, the pushrod 300 and a positioning assembly 400.

In detail, the base body 100 includes a driving portion 110, a sliding path 120 and a positioning slot 130. The driving portion 110 is disposed at one end of the base body 100 and includes a receiving space 111. The sliding path 120 is disposed in the base body 100 and communicated to the receiving space 111. The positioning slot 130 is communicated to the sliding path 120. The ratchet 200 is disposed in the receiving space 111 and includes a continuous tooth-shaped structure 210. The continuous tooth-shaped structure 210 is disposed at an outer circumference of the ratchet 200.

The pushrod 300 is disposed in the sliding path 120 and includes two tooth portions 310, two pushrod ends 320, a positioning portion 330 and a pushrod cross section 340. One of the tooth portions 310 is engaged to the continuous tooth-shaped structure 210. The two pushrod ends 320 are disposed at an end of each of the tooth portions 310, respectively, and include a tooth end surface 321 (shown in FIG. 7). The tooth end surface 321 can be a rectangle-shaped cross section and connected to the tooth portions 310. The rectangle-shaped cross section can be a horizontal rectangle-shaped cross section. The positioning portion 330 is corresponded to the positioning slot 130, and the positioning portion 330 includes at least two positioning grooves. The pushrod cross section 340 is a cross section along the line A-A of the pushrod 300 in FIG. 2. The pushrod cross section 340 includes a first cross section 341 and a second cross section 342. The first cross section 341 is a rectangular shape so as to increase an engaging area between the tooth portion 310 of the pushrod 300 and the continuous tooth-shaped structure 210 of the ratchet 200, so that the ratchet wrench 10 with the pushrod 300 can bear a greater torque. The first cross section 341 is a cross section which is close to the ratchet 200 relative to the second cross section 342. The second cross section 342 is connected to the first cross section 341, and a shape of the first cross section 341 is different from a shape of the second cross section 342. In detail, the second cross section 342 is an arc shape, such as a fan shape or a circular arc shape so as to increase the adaptability of the pushrod 300 sliding in the sliding path 120. The pushrod cross section 340 has a first horizontal length D11 and a first vertical length D12, and the first vertical length D12 is greater than the first horizontal length D11, so that an engaging position between the tooth portion 310 and the continuous tooth-shaped structure 210 can be raised. Therefore, when the ratchet 200 is driven, a vertical force can be decreased and a horizontal force can be enhanced, so that the ratchet wrench 10 with the pushrod 300 can bear the greater torque, and the adaptability of the pushrod 300 sliding in the sliding path 120 can be increased.

The positioning assembly 400 is disposed in the positioning slot 130, and the positioning assembly 400 is elastically abutted against the positioning portion 330. When the positioning assembly 400 is abutted against different positioning grooves, the ratchet wrench 10 with the pushrod 300 can provide different using modes.

In order to position the ratchet 200 in the receiving space 111, the base body 100 can further include a C-ring 140. The C-ring 140 can fix the ratchet 200 in the receiving space 111.

In FIG. 3, the shape of the first cross section 341 is different from the shape of the second cross section 342. The second cross section 342 is connected to one side of the first cross section 341 which is corresponded to the ratchet 200. The shape of the second cross section 342 can be the arc shape so as to increase the adaptability of the pushrod 300 sliding in the sliding path 120. The shape of the first cross section 341 can be a square shape so as to increase an area of the tooth portions 310 for increasing the engaging area between the tooth portion 310 of the pushrod 300 and the continuous tooth-shaped structure 210 of the ratchet 200, thus the ratchet wrench 10 with the pushrod 300 can bear the greater torque. Further, because the first cross section 341 is the square shape and the second cross section 342 is the arc shape, the first vertical length D12 is greater than the first horizontal length D11. Therefore, a vertical height of the pushrod 300 can be increased, so that the ratchet wrench 10 with the pushrod 300 can bear a further greater torque, and the adaptability of the pushrod 300 sliding in the sliding path 120 can be increased. The first cross section 341 includes two curve-shaped corners 3411. The curve-shaped corners 3411 are the two corners of the first cross section 341 which are close to the ratchet 200, and each of the curve-shaped corners 3411 has a first curve-shaped radius. The second cross section 342 includes a curve-shaped side edge 3421. The curve-shaped side edge 3421 has a second curve-shaped radius. The second curve-shaped radius is greater than each of the first curve-shaped radii.

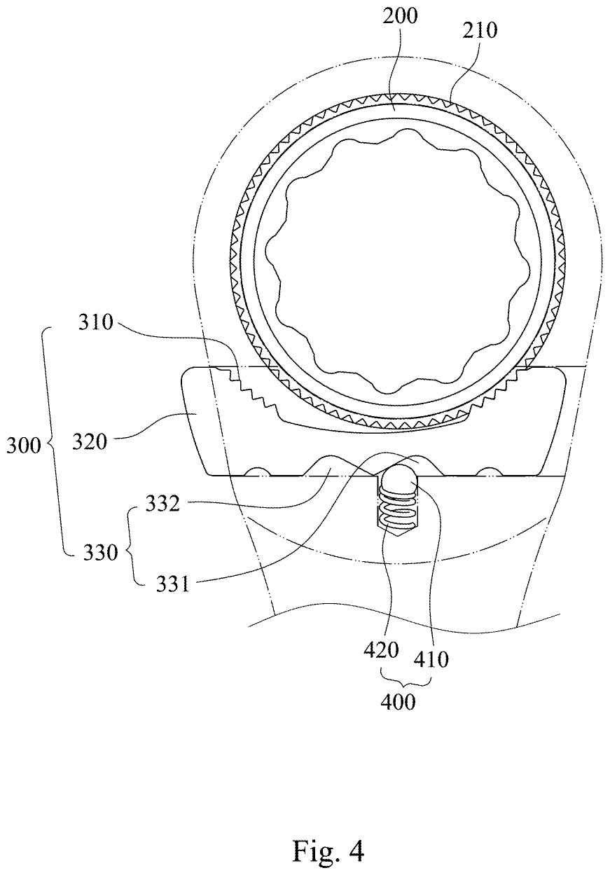

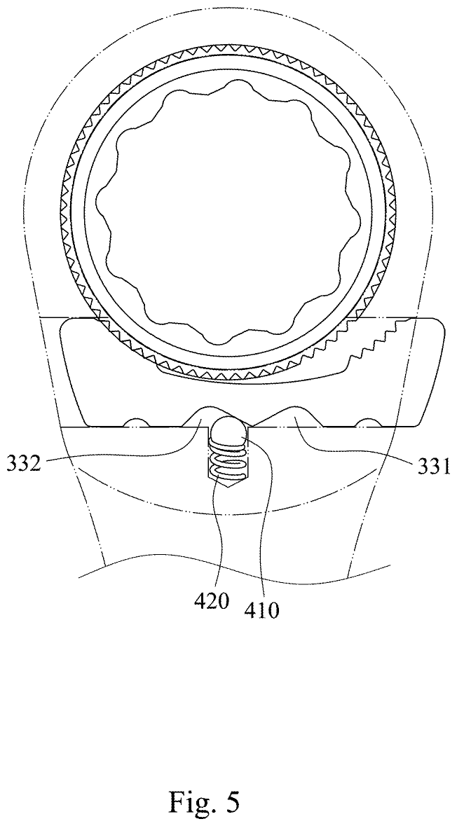

FIG. 4 is a perspective view of one status of a part of the ratchet wrench 10 with the pushrod 300 according to the embodiment of FIG. 1. FIG. 5 is a perspective view of another status of a part of the ratchet wrench 10 with the pushrod 300 according to the embodiment of FIG. 1. The positioning portion 330 can include at least two positioning grooves. In FIGS. 4 and 5, a number of the positioning groove is two, which are a first positioning groove 331 and a second positioning groove 332, respectively. The positioning assembly 400 includes a steel ball 410 and a spring 420. The spring 420 is abutted against the steel ball 410. When the user pushes the pushrod 300 to switch the using modes of the ratchet wrench 10 with the pushrod 300, the spring 420 is elastically telescoped so as to embed the positioning assembly 400 into the positioning slot 130 or push the steel ball 410 into one of the positioning grooves for ensuring the using mode. In FIG. 4, when the positioning slot 130 is corresponded to the first positioning groove 331, the positioning assembly 400 is abutted against the first positioning groove 331, and the ratchet wrench 10 with the pushrod 300 is in a first using mode. When the user want to switch the using modes of the ratchet wrench 10 with the pushrod 300, the user can push the pushrod 300, and the pushrod 300 can be moved in the sliding path 120, and the positioning assembly 400 is detached from the first positioning groove 331 and abutted against the second positioning groove 332, that is, the positioning slot 130 is corresponded to the second positioning groove 332, and the ratchet wrench 10 with the pushrod 300 is in a second using mode, as shown in FIG. 5. The first using mode can be a right-rotating mode, and the second using mode can be a left-rotating mode.

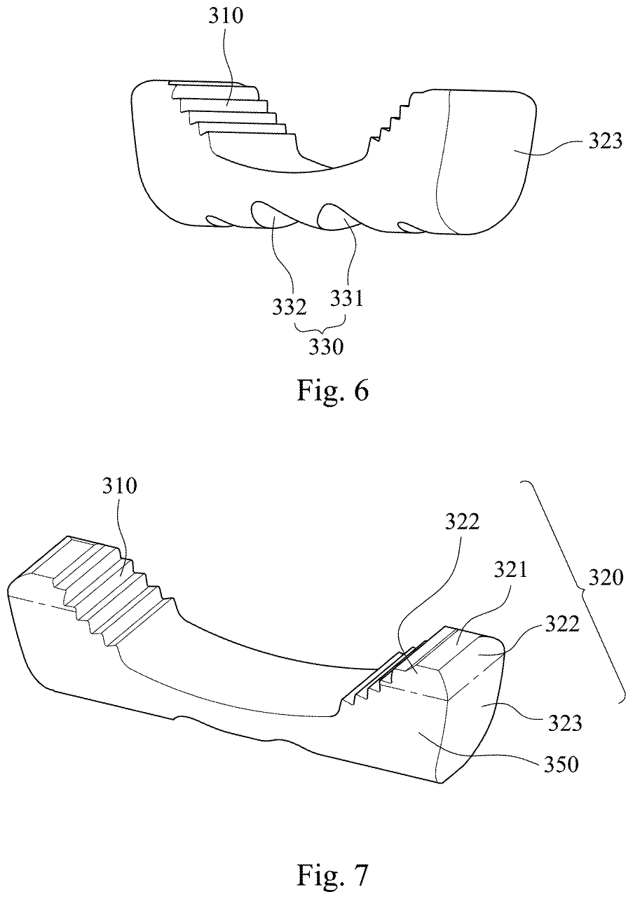

FIG. 6 is a schematic view of the pushrod 300 according to the embodiment of FIG. 1. FIG. 7 is another schematic view of the pushrod 300 according to the embodiment of FIG. 1. The pushrod 300 can further include two side surfaces 350. Each of the pushrod ends 320 can further include a pushrod outer surface 323 and a curve-shaped extending portion 322. The pushrod outer surface 323 is an outer surface of each of the two pushrod ends 320. The curve-shaped extending portion 322 is curvedly extended from the tooth end surface 321 to the side surfaces 350 and the pushrod outer surface 323. The pushrod 300 can be put into the sliding path 120 more easily by the arrangement of the curve-shaped extending portion 322.

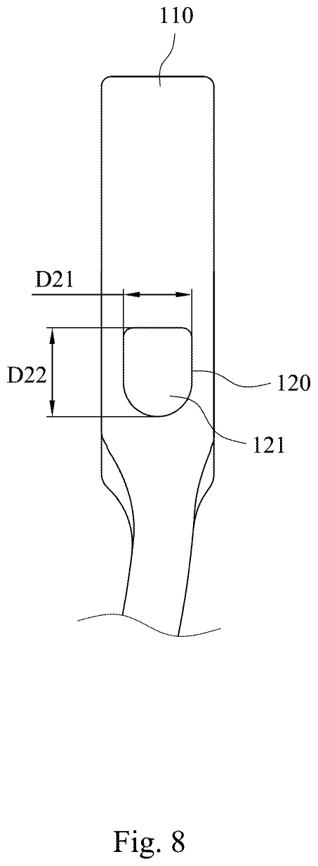

FIG. 8 is a side view of a part of the ratchet wrench 10 with the pushrod 300 according to the embodiment of FIG. 1. In FIG. 8, the sliding path 120 includes a sliding path cross section 121. The sliding path cross section 121 includes a second horizontal length D21 and a second vertical length D22. The second vertical length D22 is greater than the second horizontal length D21. A shape of the sliding path cross section 121 and a shape of the pushrod cross section 340 are the same which is for putting the pushrod 300 into the sliding path 120 easily and fixedly so as to avoid that the pushrod 300 cannot be accurately engaged to the ratchet 200.

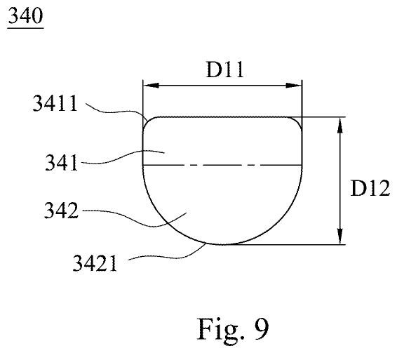

FIG. 9 is a schematic view of a pushrod cross section 340 of a ratchet wrench 10 with a pushrod 300 according to another embodiment of the present disclosure. In FIG. 9, the ratchet wrench 10 with the pushrod 300 includes a base body 100, a ratchet 200, the pushrod 300 and a positioning assembly 400. The base body 100, the ratchet 200 and the positioning assembly 400 according to the embodiment in FIG. 9 are the same as the base body 100, the ratchet 200 and the positioning assembly 400 in FIGS. 1 and 2, so that the description hereafter will refer to FIGS. 1 and 2.

In detail, the base body 100 includes a driving portion 110, a sliding path 120 and a positioning slot 130. The driving portion 110 is disposed at one end of the base body 100, and includes a receiving space 111. The sliding path 120 is disposed in the base body 100 and communicated to the receiving space 111. The positioning slot 130 is communicated to the sliding path 120. The ratchet 200 is disposed in the receiving space 111, and includes a continuous tooth-shaped structure 210. The continuous tooth-shaped structure 210 is disposed at an outer circumference of the ratchet 200.

The pushrod 300 is disposed in the sliding path 120, and includes two tooth portions 310, two pushrod ends 320, a positioning portion 330 and a pushrod cross section 340. One of the tooth portions 310 is engaged to the continuous tooth-shaped structure 210. The two pushrod ends 320 are disposed at an end of each of the tooth portions 310 and include a tooth end surface 321, respectively. The tooth end surface 321 can be a rectangle-shaped cross section and connected to the tooth portions 310. The rectangle-shaped cross section can be a horizontal rectangle-shaped cross section. The positioning portion 330 is corresponded to the positioning slot 130 and includes at least two positioning grooves. The pushrod cross section 340 includes a first cross section 341 and a second cross section 342. The first cross section 341 is a rectangular shape so as to increase an engaging area between the tooth portion 310 of the pushrod 300 and the continuous tooth-shaped structure 210 of the ratchet 200, so that the ratchet wrench 10 with the pushrod 300 can bear a greater torque. The first cross section 341 is a cross section which is close to the ratchet 200 relative to the second cross section 342. The second cross section 342 is connected to the first cross section 341, and a shape of the first cross section 341 is different from a shape of the second cross section 342. In detail, the second cross section 342 is an arc shape, such as a fan shape or a circular arc shape so as to increase the adaptability of the pushrod 300 sliding in the sliding path 120. The pushrod cross section 340 has a first horizontal length D11 and a first vertical length D12, and the first horizontal length D11 is greater than the first vertical length D12 to increase the engaging area between the tooth portion 310 and the continuous tooth-shaped structure 210 of the ratchet 200, so that the ratchet wrench 10 with the pushrod 300 can bear the greater torque. The first cross section 341 includes two curve-shaped corners 3411. The curve-shaped corners 3411 are the corners of the first cross section 341 which are close to the ratchet 200, and each of the curve-shaped corners 3411 has a first curve-shaped radius. The second cross section 342 includes a curve-shaped side edge 3421. The curve-shaped side edge 3421 has a second curve-shaped radius. The second curve-shaped radius is greater than each of the first curve-shaped radii.

The arrangements of the positioning assembly 400, the positioning slot 130 and the positioning portion 330 according to the embodiment in FIG. 9 are same with the arrangements of the positioning assembly 400, the positioning slot 130 and the positioning portion 330 according to the embodiment in FIGS. 1 and 2, and will not be described again herein.

The arrangements of the positioning portion 330 and the positioning assembly 400 according to the embodiment in FIG. 9 are same with the arrangements of the positioning portion 330 and the positioning assembly 400 according to the embodiment in FIGS. 4 and 5, and will not be described again herein.

The arrangements of the pushrod 300 according to the embodiment in FIG. 9 is same with a structure of the pushrod 300 according to the embodiment in FIGS. 6 and 7, and will not be described again herein.

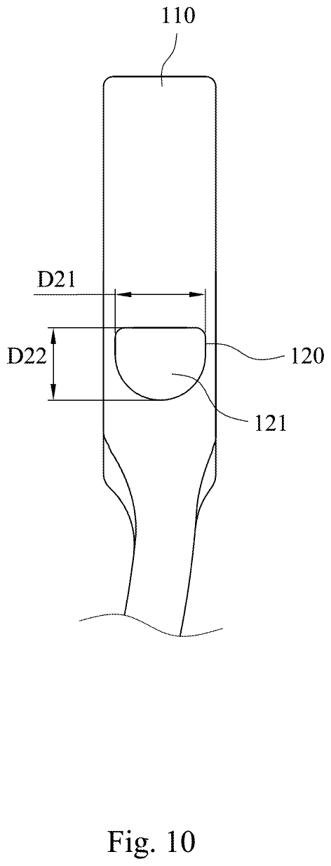

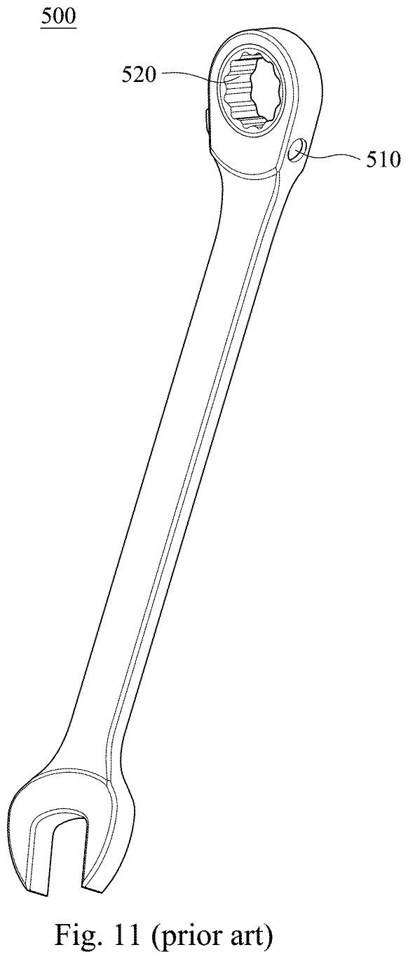

FIG. 10 is a side view of a part of the ratchet wrench 10 with the pushrod 300 according to the embodiment of FIG. 9. In FIG. 10, the sliding path 120 includes a sliding path cross section 121. The sliding path cross section 121 includes a second horizontal length D21 and a second vertical length D22. The second horizontal length D21 is greater than the second vertical length D22. A shape of the sliding path cross section 121 and a shape of the pushrod cross section 340 are the same which is for putting the pushrod 300 into the sliding path 120 easily and fixedly so as to avoid that the pushrod 300 cannot be accurately engaged to the ratchet 200.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A ratchet wrench with a pushrod, comprising:
a base body, comprising:
a driving portion disposed at one end of the base body, and comprising a receiving space;
a sliding path disposed in the base body and communicated to the receiving space; and
a positioning slot communicated to the sliding path;
a ratchet disposed in the receiving space, and comprising:
a continuous tooth-shaped structure disposed at an outer circumference of the ratchet;
the pushrod disposed in the sliding path, and comprising:
two tooth portions, wherein one of the two tooth portions is engaged to the continuous tooth-shaped structure;
two pushrod ends disposed at an end of each of the two tooth portions, respectively;
a positioning portion corresponded to the positioning slot, and comprising at least two positioning grooves; and
a pushrod cross section comprising:
a first cross section being a rectangular shape; and
a second cross section being an arc shape and connected to the first cross section, wherein the pushrod cross section has a first horizontal length and a first vertical length, and the first vertical length is greater than the first horizontal length; and
a positioning assembly disposed in the positioning slot, wherein the positioning assembly is elastically abutted against the positioning portion.

2. The ratchet wrench with the pushrod of claim 1, wherein the first cross section is a square shape.

3. The ratchet wrench with the pushrod of claim 1, wherein the sliding path comprises a sliding path cross section, and the sliding path cross section has a second horizontal length and a second vertical length, and the second vertical length is greater than the second horizontal length.

4. The ratchet wrench with the pushrod of claim 1, wherein the second cross section is a circular arc shape.

5. The ratchet wrench with the pushrod of claim 1, wherein the pushrod cross section further comprises:
two curve-shaped corners, each of the two curve-shaped corners having a first curve-shaped radius; and
a curve-shaped side edge having a second curve-shaped radius.

6. The ratchet wrench with the pushrod of claim 5, wherein the second curve-shaped radius is greater than each of the first curve-shaped radii.

7. The ratchet wrench with the pushrod of claim 1, wherein,
the pushrod further comprises two side surfaces; and
each of the two pushrod ends comprises:
a pushrod outer surface being an outer surface of each of the two pushrod ends;
a tooth end surface connected to each of the two tooth portions; and
a curve-shaped extending portion curvedly extended from the tooth end surface to the side surfaces and the pushrod outer surface.

8. A ratchet wrench with a pushrod, comprising:
a base body, comprising:
a driving portion disposed at one end of the base body, and comprising a receiving space;
a sliding path disposed in the base body and communicated to the receiving space; and
a positioning slot communicated to the sliding path;
a ratchet disposed in the receiving space, and comprising:
a continuous tooth-shaped structure disposed at an outer circumference of the ratchet;
the pushrod disposed in the sliding path, and comprising:
two tooth portions, wherein one of the two tooth portions is engaged to the continuous tooth-shaped structure;
two pushrod ends disposed at an end of each of the two tooth portions, respectively;
a positioning portion corresponded to the positioning slot, and comprising at least two positioning grooves; and
a pushrod cross section comprising:
a first cross section being a rectangular shape; and
a second cross section being an arc shape and connected to the first cross section, wherein the pushrod cross section has a first horizontal length and a first vertical length, and the first horizontal length is greater than the first vertical length; and
a positioning assembly disposed in the positioning slot, wherein the positioning assembly is elastically abutted against the positioning portion.

9. The ratchet wrench with the pushrod of claim 8, wherein the sliding path comprises a sliding path cross section, and the sliding path cross section has a second horizontal length and a second vertical length, and the second horizontal length is greater than the second vertical length.

10. The ratchet wrench with the pushrod of claim 8, wherein the second cross section is a circular arc shape.

11. The ratchet wrench with the pushrod of claim 8, wherein the pushrod cross section further comprises:
two curve-shaped corners, each of the two curve-shaped corners having a first curve-shaped radius; and
a curve-shaped side edge having a second curve-shaped radius.

12. The ratchet wrench with the pushrod of claim 11, wherein the second curve-shaped radius is greater than each of the first curve-shaped radii.

13. The ratchet wrench with the pushrod of claim 8, wherein,
the pushrod further comprises two side surfaces; and
each of the two pushrod ends comprises:
a pushrod outer surface being an outer surface of each of the two pushrod ends;
a tooth end surface connected to each of the two tooth portions; and
a curve-shaped extending portion curvedly extended from the tooth end surface to the side surfaces and the pushrod outer surface.
